(19) United States
(12) Patent Application Publication
(10) Pub. No.: US 2024/0111814 A1
(43) Pub. Date: Apr. 4, 2024

(54) METHOD AND SYSTEM FOR SELECTING SAMPLES TO REPRESENT A CLUSTER

(71) Applicant: L&T TECHNOLOGY SERVICES LIMITED, Chennai (IN)

(72) Inventors: Ishita DAS, Kolkata (IN); Madhusudan SINGH, Bangalore (IN); Mridul BALARAMAN, Bangalore (IN); Sukant DEBNATH, Ahmedabad (IN); Mrinal GUPTA, Jammu (IN)

(21) Appl. No.: 18/010,757

(22) PCT Filed: Mar. 15, 2022
(86) PCT No.: PCT/IB2022/052333

§ 371 Date: Dec. 15, 2022

(30) Foreign Application Priority Data
Jun. 25, 2021 (IN) 202141028706

(51) Int. Cl. G06F 16/906

(52) U.S. Cl. CPC G06F 16/906

(57) ABSTRACT

A method of selecting samples to represent a cluster is disclosed. The method may include receiving one or more clusters by an optimization device. Each of the one or more clusters may include a plurality of samples. The method may determine a count of number of samples to be selected from each of the one or more clusters and may generate an array-based distance matrix for each of the one or more clusters. The method may sort the plurality of samples of the cluster based on a degree of variability of the plurality of samples in the cluster. The sorting may be performed using the array-based distance matrix for each of the one or more clusters. Further, the method may select the determined count of number of samples from the sorted plurality of samples of each of the plurality of clusters to represent the cluster.

### TECHNICAL FIELD

This disclosure relates generally to reducing size of a dataset, and more particularly to selecting plurality of samples to represent a cluster for reducing size of a dataset.

### BACKGROUND

In an era of big data with information explosion, business requirement related to data processing is increasing each day, and data samples to be processed are becoming more and more complicated. Data clustering is a crucial field in engineering systems and computational science and uses an unsupervised learning to train a machine learning model without any labelled data. Clustering algorithms divides data in number of clusters having unique features of their own. Sometimes these clusters themselves have huge number of samples. The unlabelled data is available in high dimensions and in linearly inseparable data spaces thereby leading to consuming a large memory chunk and time during processing and training of a machine learning model.

There is therefore a need in the art to provide a method and system for reducing size of a dataset by reducing a count of total number of samples in a cluster for effective and resource efficient training of the machine learning model.

### SUMMARY OF THE INVENTION

A method of selecting samples to represent a cluster is disclosed. The method may include receiving one or more clusters by an optimization device. Each of the one or more clusters may include a plurality of samples. The method may determine a count of number of samples to be selected from each of the one or more clusters and may generate an array-based distance matrix for each of the one or more clusters. The method may sort the plurality of samples of the cluster based on a degree of variability of the plurality of samples in the cluster. The sorting may be performed using the array-based distance matrix for each of the one or more clusters. Further, the method may select the determined count of number of samples from the sorted plurality of samples of each of the plurality of clusters to represent the cluster.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a process for selection of a plurality of data samples from one or more clusters, in accordance with an embodiment of the present disclosure.

FIG. 2 illustrates a process for sorting and selecting a plurality of data samples from one or more clusters, in accordance with some embodiments of the present disclosure.

FIG. 3 is flowchart of a method of selecting samples to represent a cluster, in accordance with some embodiments of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

As it will be appreciated, clustering algorithms divide data in number of clusters having unique features of their own. Sometimes these clusters themselves have huge number of samples. The present disclosure provides a solution where a cluster can be represented using a limited number of samples which cover the variability, properties inherent to the cluster. This way the algorithm reduces the dependency to use entire dataset for further process thereby limiting the memory and time complexity of working with large datasets. The algorithm is also flexible which allows users to select required number of samples from a cluster if the size of itis small. Further, the process ensures that unique samples from even a homogenous cluster can be selected.

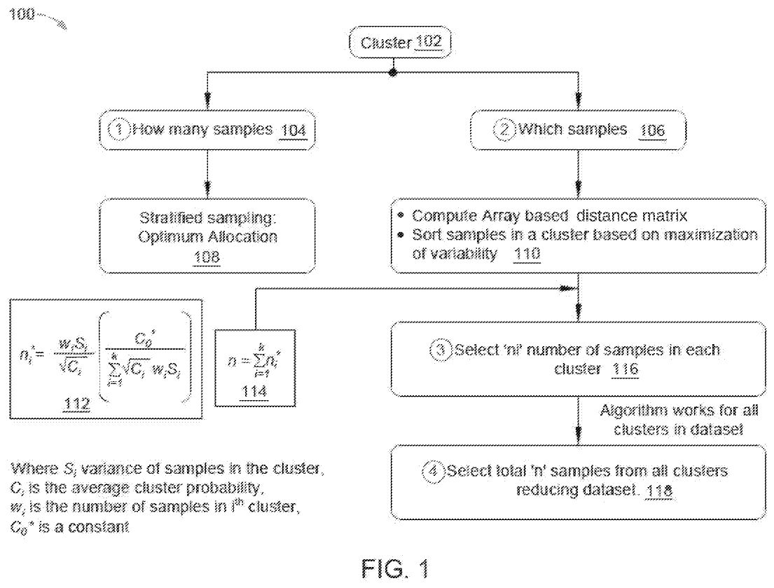

Referring to FIG. 1, a process 100 for selection of a plurality of data samples from one or more clusters is illustrated, in accordance with an embodiment of the present disclosure.

At step 102, a dataset may be clustered into the one or more different clusters. The clustering may be performed to ensure that the dataset that look alike and has similar features is maintained together in a particular cluster.

At step 104, it may be determined that how many of data samples of the plurality of data samples may be selected from a cluster of the one or more different created clusters.

To determine how many data samples are to be selected, a stratified sampling mechanism for an optimum allocation may be used. The stratified sampling mechanism may take into consideration the plurality of data samples. Each of the plurality of data samples maybe divided into a homogeneous group (i.e., a cluster, where each of the plurality of data samples that have similar features may be stored together). The determination may relate to how many samples may be selected from among multiple similar looking samples. At step 106, it may be determined that which of the data samples may be selected from the one or more different clusters. A stratified sampling mechanism may select one of a particular homogenous data group and may randomly select one or more data samples based on a particular calculation.

For a given cluster, at step 108, a Nᵢ number of samples may be selected from the cluster using the below mentioned equation:

$${n}_{i} = \frac{{w}_{i} {s}_{i}}{\sqrt{{c}_{i}}} / \frac{{c}_{o}}{{\sum }_{i = 1}^{k} \sqrt{{c}_{i} {w}_{i} {s}_{i}}} I . \qquad eq ( 1 )$$

Where: wᵢ is a number of data samples present in a i^{th} cluster,
Sᵢ is a variance of data samples in the cluster,
Cᵢ is an average cluster probability, and
C_{O} is a constant.

The equation (1) may be reduced to:

n=Σᵢ₌₁^{k}nᵢ eq (2)

The equation (2) may take into account size and variability of the cluster.

In case a machine learning model is available for differentiating between multiple data samples present within the cluster and is also capable of predicting a correct level of differentiation between the multiple data samples based on a given set of features, then learning derived from the machine learning model may be utilized to determine how many of the data samples may be selected from the cluster by considering the cluster probability. In case the learning related to level of differentiation is not available from any of the available machine learning models, then the cluster probability parameter may be given a lesser weightage for determining selection of the number of data samples.

At step 106, a determination related to which of the data samples are to be selected maybe performed. Generally, the data samples may be selected randomly based on any of an available random selection mechanism. However, to maximize degree of variability of the cluster so that the selected data samples represent the entire cluster, a distance based selection mechanism may be utilized at step 110. In the distance based selection mechanism an array based optimized distance matrix present within a cluster may be utilized. The distance matrix may be for example, an Euclidean based distance matrix or a Manhattan based distance matrix. Further, the data samples may be sorted based on their distance i.e., based on maximization of variability.

At step 116, a ‘nᵢ’ number of data samples may be selected in each of the cluster of the one or more clusters using the equation (2). Further, a procedure of selecting the ‘nᵢ’ number of data samples may be repeated for all the clusters of the one or more clusters of the dataset. In a specific scenario, when a number of the data samples selected from the cluster are minimal, the process 100 may select a predetermined count of the number of samples from each of the one or more clusters. This may be done when the selected determined count of the number of samples is less than a threshold value. At step 118, a total of ‘n’ data samples may be selected from each of the one or more clusters thereby reducing size of the dataset.

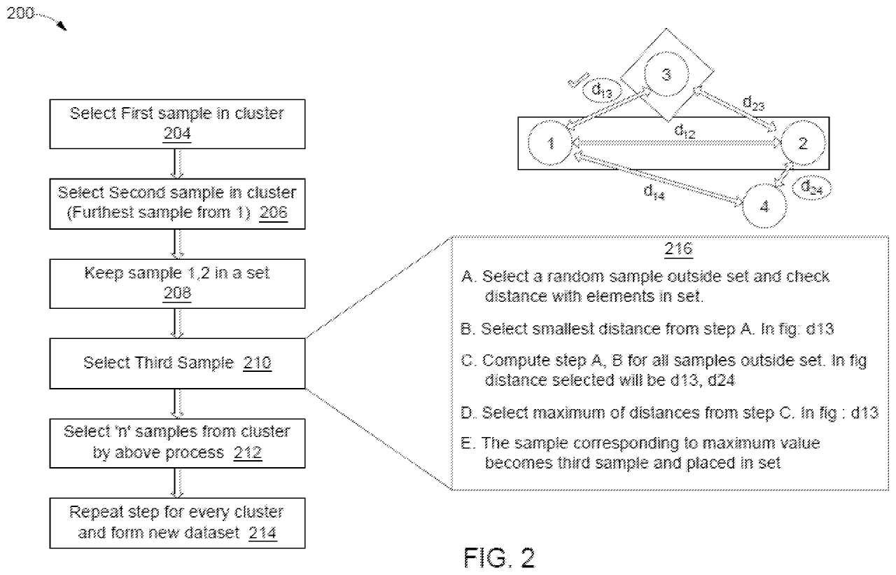

Referring now to FIG. 2, a process 200 for sorting and selecting a plurality of data samples from one or more clusters is illustrated, in accordance with some embodiments of the present disclosure.

At step 204, a first data sample may be selected from a cluster of the one or more clusters. At step 206, a second data sample may be selected which is furthest from the first selected sample. At step 208, the first data sample and the second sample may be maintained in a dataset. At step 210, a third data sample may be selected. The selection of the third data sample may be performed as per a mechanism at step 216, where a random sample from outside the dataset, for example, the third data sample may be selected. Distance of the data samples of the data set with respect to data samples outside the dataset may be determined. For example, a distance of the third data sample may be determined with respect to the first data sample of the data set as ‘d13’ and with the second data sample of the data set as ‘d23’.

Smaller of distance of the distance ‘d13’ and the distance ‘d23’ may be selected. The smaller distance may be, for example, ‘d13’ as is illustrated in FIG. 2. Further, for all the data samples present outside the dataset the above mentioned steps of checking the distance and selecting a smallest distance may be determined. For example, another data sample outside the dataset may be a fourth data sample, and the determined distance may be, for example, from the first data sample of the data set to the fourth data sample as ‘d14’ and from the second data sample of the data set as ‘d24’.

Subsequently smallest of the determined distances may be determined as, for example, ‘d13’ and ‘d24’. Next, a maximum distance from the smallest determined distances may be selected, for example, ‘d13’. Finally, a data sample, for example, the third sample corresponding to the maximum distance, for example, ‘d13’ may be selected and may be inserted in the dataset.

By using the stratified sampling mechanism and by sorting the data samples in the cluster based on maximization of variability, at step 212, ‘nᵢ’ samples may be selected from the cluster of the one or more clusters such that the selected samples may be unique and cover entire variability of the cluster.

At step 214, the above described steps 204-212 may be repeated for each of the cluster of the one or more clusters to create a new reduced dataset which maintains properties of the dataset.

In an exemplary embodiment, assume that there is a dataset of handwritten alphabets. In the dataset, alphabet ‘a’ may be written in varied forms by different users such as in italics form, bold form, in different font size, or in cursive form. Further, the alphabets may be clustered based on whether the alphabets lie in category of alphabets such as ‘a’, ‘b’, ‘c’, and so on. Considering a plurality of data samples from the cluster of alphabet ‘a’. Suppose italics form of ‘a’ may be fewer in numbers in the cluster of the alphabet ‘a’. For example, in the dataset having 50K data samples only 5K data samples may represent italics form of alphabet ‘a’ and thus may represent uniqueness of the italics form of ‘a’ in the 50K data samples. The unique italics form of ‘a’ may be used to arrange and sort the data samples. Therefore, it may be concluded that from 50K samples, 5K samples may be used to represent the italics form of the alphabet ‘a’. Further, which of these represented 5K samples are to be picked may be determined by a sorting mechanism based on a maximization of variability of the data samples in the cluster.

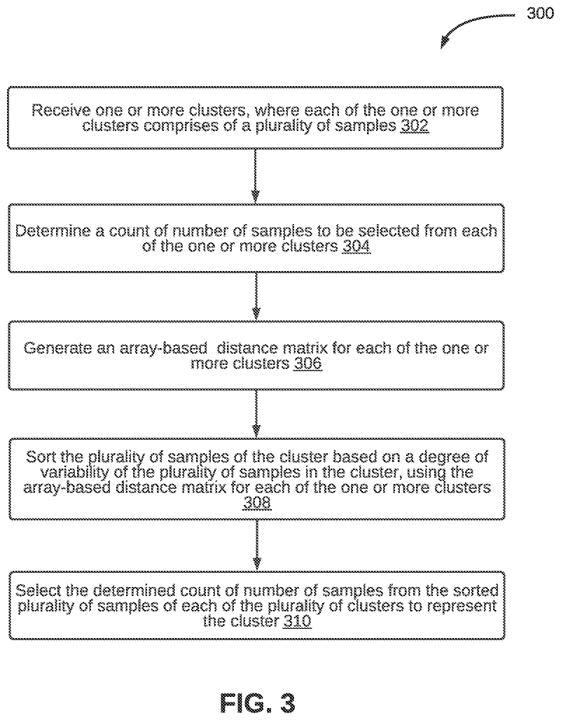

Referring now to FIG. 3, a flowchart of a method 300 of selecting samples to represent a cluster is illustrated in accordance with an embodiment. At step 302, one or more clusters may be received. Each of the one or more clusters may include of a plurality of samples.

At step 304, a count of number of samples to be selected from each of the one or more clusters may be determined. The count of number of samples to be selected from each of the one or more clusters may be determined based on at least one of a size, a variability, and a cluster probability for each of the one or more clusters, using a Stratified Sampling technique. The cluster probability may be determined using a machine learning (ML) model, where the ML model classifies the plurality of samples of the cluster. It may be noted that in case of untrained ML model, each cluster may be assigned equal probability.

At step 306, an array-based distance matrix may be generated for each of the one or more clusters. For example, the array-based distance matrix may be a Euclidean distance matrix. At step 308, the plurality of samples of the cluster may be sorted based on a degree of variability of the plurality of samples in the cluster, using the array-based distance matrix for each of the one or more clusters; and

At step 310, the determined count of number of samples may be selected from the sorted plurality of samples of each of the plurality of clusters to represent the cluster. In some embodiments, additionally, a predetermined count of the number of samples may be selected from each of the one or more clusters, when the selected determined count of the number of samples is less than a threshold value.

One or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It will be appreciated that, for clarity purposes, the above description has described embodiments of the disclosure with reference to different functional units and processors. However, it will be apparent that any suitable distribution of functionality between different functional units, processors or domains may be used without detracting from the disclosure.

For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present disclosure has been described in connection with some embodiments, it is not intended to be limited to the specific form set forth herein. Rather, the scope of the present disclosure is limited only by the claims. Additionally, although a feature may appear to be described in connection with particular embodiments, one skilled in the art
would recognize that various features of the described embodiments may be combined in accordance with the disclosure.

Furthermore, although individually listed, a plurality of means, elements or process steps may be implemented by, for example, a single unit or processor. Additionally, although individual features may be included in different claims, these may possibly be advantageously
combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

We claim:

1. A method for selecting samples to represent a cluster, the method comprising:
receiving, by an optimization device, one or more clusters, where each of the one or more clusters comprises of a plurality of samples;
determining, by the optimization device, a count of number of samples to be selected from each of the one or more clusters;
generating, by the optimization device, an array-based distance matrix for each of the one or more clusters;
sorting, by the optimization device, the plurality of samples of the cluster based on a degree of variability of the plurality of samples in the cluster, using the array-based distance matrix for each of the one or more clusters; and
selecting, by the optimization device, the determined count of number of samples from the sorted plurality of samples of each of the plurality of clusters to represent the cluster.

2. The method as claimed in claim 1, comprising:
selecting a predetermined count of the number of samples from each of the one or more clusters, when the selected determined count of the number of samples is less than a threshold value, wherein the threshold value is specific to each dataset, and wherein the threshold value is determined by comparing the size of a cluster with respect to the dataset.

3. The method as claimed in claim 1, wherein the count of number of samples to be selected from each of the one or more clusters is determined based on at least one of a size, a variability, and a cluster probability for each of the one or more clusters, using a Stratified Sampling technique.

4. The method as claimed in claim 3, wherein the cluster probability is determined using a machine learning (ML) model, where the ML model classifies the plurality of samples of the cluster.

5. A system comprising:
one or more computing devices configured to:
receive, by an optimization device, one or more clusters, where each of the one or more clusters comprises of a plurality of samples;
determine, by the optimization device, a count of number of samples to be selected from each of the one or more clusters;
generate, by the optimization device, an array-based distance matrix for each of the one or more clusters;
sort, by the optimization device, the plurality of samples of the cluster based on a degree
of variability of the plurality of samples in the cluster, using the array-based distance matrix for each of the one or more clusters; and
select, by the optimization device, the determined count of number of samples from the sorted plurality of samples of each of the plurality of clusters to represent the cluster.

6. The system as claimed in claim 5, comprising:
selecting a predetermined count of the number of samples from each of the one or more clusters, when the selected determined count of the number of samples is less than a threshold value, wherein the threshold value is specific to each dataset, and wherein the threshold value is determined by comparing the size of a cluster with respect to the dataset.

7. The system as claimed in claim 5, wherein the count of number of samples to be selected from each of the one or more clusters is determined based on at least one of a size, a variability, and a cluster probability for each of the one or more clusters, using a Stratified Sampling technique.

8. The system as claimed in claim 7, wherein the cluster probability is determined using a machine learning (ML) model, where the ML model classifies the plurality of samples of the cluster.
